(19) United States
(12) Patent Application Publication
(10) Pub. No.: US 2012/0262792 A1
(43) Pub. Date: Oct. 18, 2012

(54) OPTICAL GLASS FILTER FOR PRODUCING BALANCED WHITE LIGHT FROM A HIGH PRESSURE SODIUM LAMP SOURCE

(75) Inventors: Jeffrey Goldberg, Capitola, CA (US); Barry Shiller, San Martin, CA (US)

(73) Assignee: APPLIED BOTANICS, INC. DBA METHOD SEVEN, Soquel, CA (US)

(21) Appl. No.: 13/444,296

(22) Filed: Apr. 11, 2012

Related U.S. Application Data
(60) Provisional application No. 61/476,058, filed on Apr. 15, 2011.

(51) Int. Cl. G02B 1/10; C09K 3/00

(52) U.S. Cl. 359/601; 252/582

(57) ABSTRACT

In various embodiments, the present invention provides a way to provide natural looking colors in an environment where HPS lighting is used. In at least one embodiment, the present invention is implemented as a color-enhanced glass lens that filters red/yellow light, ultraviolet light, and infrared radiation created by High Pressure Sodium (HPS) lighting and other forms of sodium flare, and in addition balances the remaining visual light spectrum to provide a natural white color appearance referred to as Daylight Balanced Light (DBL). DBL is achieved by balancing the color spectrum under HPS conditions to approximate what the human eye perceives as natural white light as provided by natural sunlight (5500° Kelvin). In various embodiments, the techniques of the present invention can be used to manufacture lenses, filters, windows, eyeglasses, sunglasses, contact lenses, and the like.

### CROSS-REFERENCE TO RELATED APPLICATIONS

The present application claims priority from U.S. Provisional Application Ser. No. 61/476,058 for “Optical Glass Filter for Producing Balanced White Light from a High Pressure Sodium Lamp Source,” filed Apr. 15, 2011, the entire disclosure of which is incorporated herein by reference.

### FIELD OF THE INVENTION

The present invention relates to filters that are used for changing the spectral characteristics of light.

### BACKGROUND

High Pressure Sodium (HPS) light sources produce light that is often used indoors for hydroponics and warehouse lighting, as well as outdoors for street lighting and other applications. The spectrum of light from such HPS lights has a sodium flare (an undesirable yellow glare), potentially harmful ultraviolet (UV) light, and potentially harmful infrared (IR) radiation. Similarly, sodium flare is created when an oxygen/propane or acetylene touch is used to melt glass, when a propane gas powered forge is used, and when arc welding or plasma welding.

Referring now to FIG. 3, there is shown a graph 300 depicting spectral output of a typical high-pressure sodium lamp. As can be seen from graph 300, spikes 301 appear at approximately 589 nm and at other nearby wavelengths; these spikes are created by the sodium flare.

It is desirable, in many applications, to reduce or eliminate sodium flare. Prior attempts at optical solutions filter out the sodium flare or yellow glare and the UV and IR associated with sodium flare. For example, some prior solutions use a glass lens (filter) with some combination of rare earth elements, such as neodymium (Nd) and praseodymium (Pr), to filter out the associated wavelength (570-590 nanometers) of the sodium flare. This combination is often referred to as “didymium”. In addition to eliminating the 570-590 nanometer sodium flare, didymium eliminates UV (A-B-C) light below 400 nanometers and partially filters IR-A B and C light above 1000 nanometers.

When didymium glasses are used in an environment where HPS lighting is found, the didymium filters a narrow wavelength of light without rebalancing the remaining spectrum of visible light, resulting in a heavy red to pinkish tint, depending on the exact composition of the didymium and the exact thickness of the glass. Under such conditions, objects are not shown in their natural color. This color shift can be a disadvantage, for example, for indoor growers working in conditions where HPS lighting is used; such growers would ideally like to have a natural view, commonly referred to as Daylight Balanced Light (DBL). DBL is what the human eye perceives as natural white light as provided by natural sunlight when the sun is high overhead (for example, as provided by the mid-day sun on a clear day (approximately 5500° Kelvin).

### SUMMARY

In various embodiments, the present invention provides a way to provide natural looking colors in an environment where HPS lighting is used.

In at least one embodiment, the present invention is implemented as a color-enhanced glass lens that filters red/yellow light, ultraviolet light, and infrared radiation created by High Pressure Sodium (HPS) lighting and other forms of sodium flare, and in addition balances the remaining visual light spectrum to provide a natural white color appearance referred to as Daylight Balanced Light (DBL). DBL is achieved by balancing the color spectrum under HPS conditions to approximate what the human eye perceives as natural white light as provided by natural sunlight (5500° Kelvin).

In various embodiments, the techniques of the present invention can be used to manufacture lenses, filters, windows, eyeglasses, sunglasses, contact lenses, and the like.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1A depicts an example of a design for implementing the present invention in a monolithic lens, according to one embodiment.

FIGS. 1B and 1C depict an example of a design for implementing the present invention in eyeglasses, according to one embodiment.

FIGS. 2A and 2B are graphs depicting results of a spectral analysis of a lens manufactured according to an embodiment of the present invention.

FIG. 3 is a graph depicting spectral output of a typical high-pressure sodium lamp.

FIG. 4 is a graph depicting a typical spectral distribution for daylight.

### DETAILED DESCRIPTION OF THE EMBODIMENTS

In at least one embodiment, the present invention provides a monolithic filter or lens made of glass containing neodymium (Nd) and/or praseodymium (Pr) to filter red/yellow light in the 570-590 nanometer wavelength and harmful ultraviolet light and infrared radiation, with the addition of cerium oxide (cerium element #58 in the periodic table) and titanium oxide (titanium element #22). Cerium oxide and titanium oxide, which may be provided singly or in combination, attenuate blue and green light in the 470-500 nanometer wavelengths. In one embodiment, black copper oxide (copper element #29) and/or chromium oxide (chromium element #24) are added, singly or in combination, to attenuate violet light in the 430-450 nanometer wavelengths. These various elements may or may not be included, depending on fine tuning and other factors. Depending on color shift and UV absorption, other chemicals may also be substituted or changed altogether, in any suitable combination.

For example, the present invention can be implemented with neodymium, while omitting praseodymium. Alternatively, both elements can be included.

In at least one embodiment, the blue, green and violet ranges of light are attenuated to modify the light spectrum that remains after the 570-590 nanometer wavelength of light, associated with sodium flare, has been filtered out. The resulting visible light spectrum achieves and/or approximates a Daylight Balanced Light (DBL) condition, which is perceived as natural sunlight. Objects illuminated by the filtered light can thus be seen in their natural colors.

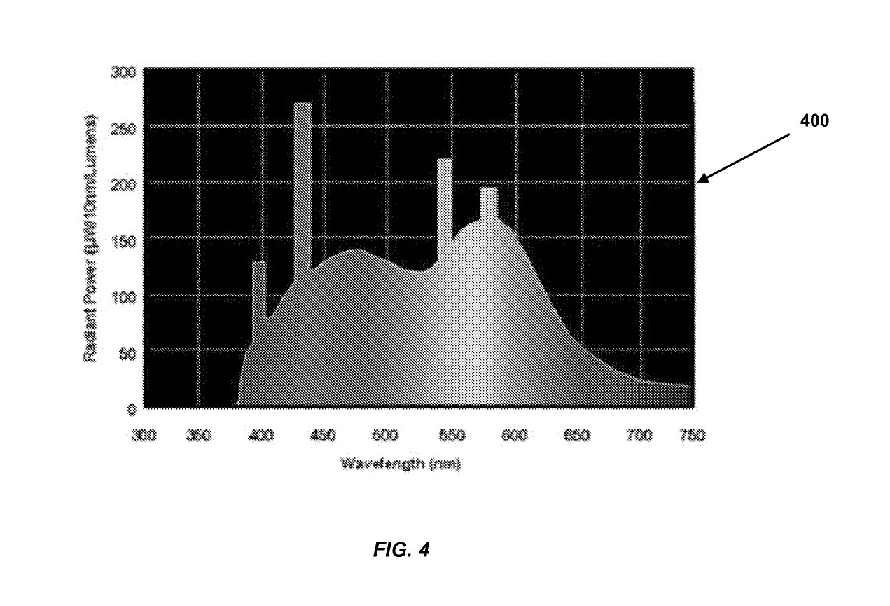

Referring now to FIG. 4, there is shown a graph 400 depicting a typical spectral distribution for daylight.

In various embodiments, the techniques of the present invention can be used to manufacture filters to be used in connection with light sources. In other embodiments, the techniques of the present invention can be used in connection with any or all of the following, singly or in any combination:
lenses;
windows;
eyeglasses;
sunglasses;
contact lenses;
glass blowing;
glass used in constructing an HPS bulb, for example to be used in a street light or architectural lighting environment;
contrast enhancement filter for aviation or other uses;
HPS to DBL conversion filter for photography and video;
protective eyewear for jewelry makers or other uses;
protective eyewear for warehouse forklift operators and other users, for example for working at night in HPS-lit environments;
and the like.

For example, the invention can be implemented as eyeglasses to be used in conditions where HPS lighting may be found, such as in indoor growing environments. Alternatively, the composition used in the present invention can be applied to architectural lighting, warehouse lighting, street lights, and/or any other area where HPS bulbs may be used. In one embodiment, the composition can be used in glass for the bulb itself, avoiding the need for a separate filter. The addition of this composition in the glass which houses the HPS inner workings, results in a UV-protected, daylight-balanced light source.

In another embodiment, the invention can be implemented as a flat photographic contrast enhancement filter.

The glass filter of the present invention is therefore able to produce perceived visual DBL while under HPS conditions.

In one embodiment, the invention is implemented as a monolithic lens. Alternatively, it can be implemented as a series of lenses, each including one or more components of the filter materials. The lenses can then be used in concert with one another. They can be affixed to one another, but need not be.

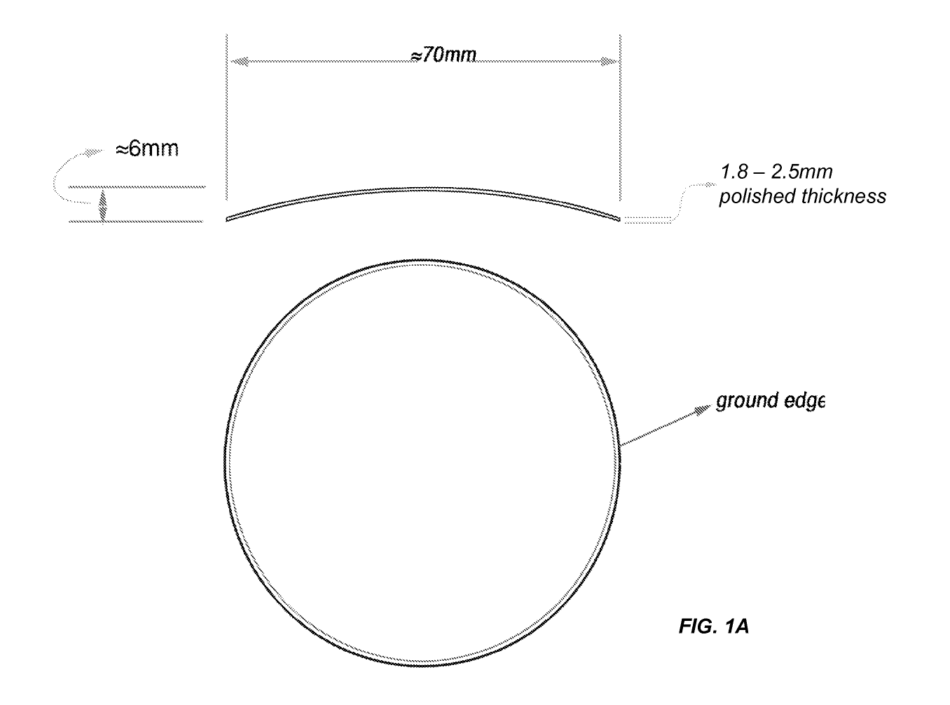

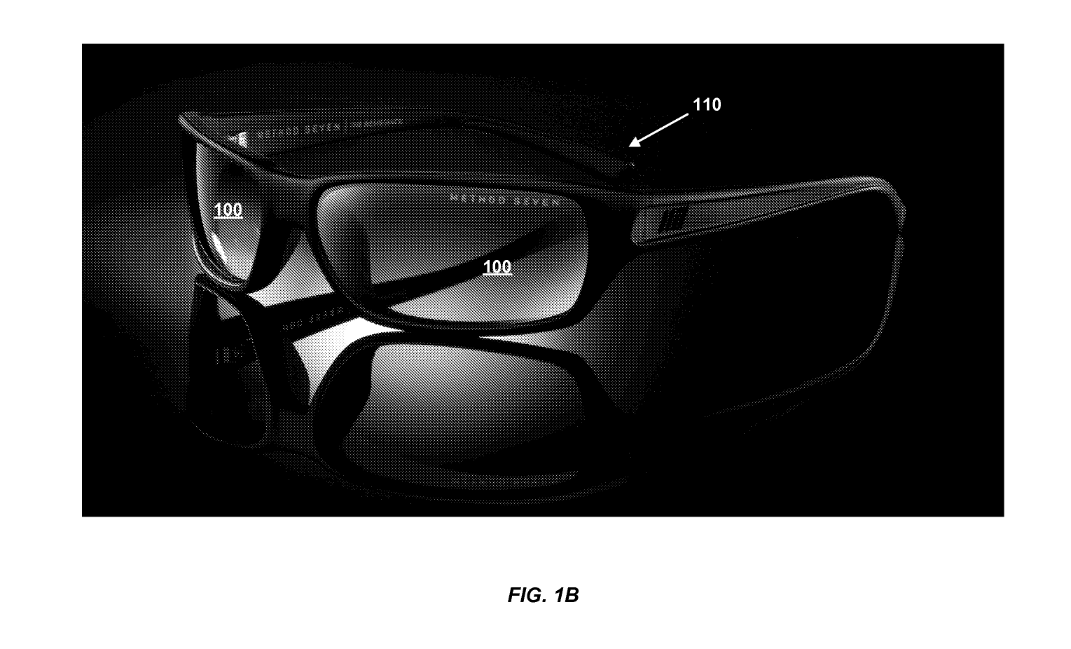

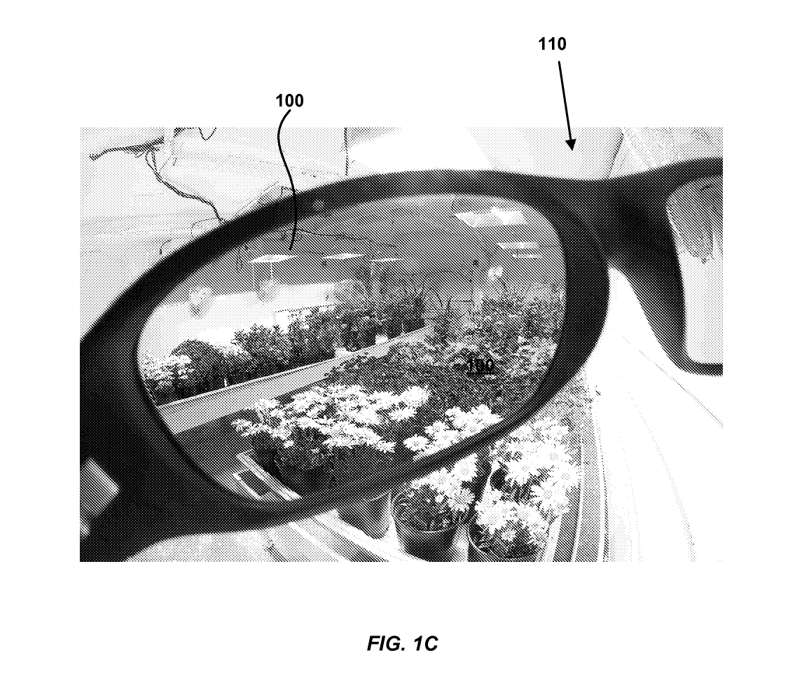

Referring now to FIG. 1A, there is shown an example of a lens design for implementing the present invention in a monolithic lens 100 according to one embodiment. Lens 100 is manufactured in such a manner that it contains the filter materials described herein, so as to filter and rebalance sodium light according to the techniques of the present invention. One skilled in the art will recognize that the depicted design is merely exemplary, and that the specified shape and/or dimensions can be varied without departing from the essential characteristics of the invention. In the depicted example, lens 100 is convex and has a diameter of approximately 70 mm. Lens 100 is depicted with ground edge 101, which is optional and can be omitted. One skilled in the art will recognize that many other types, sizes, shapes, and arrangements of lenses and/or any other light-transmission apparatuses can be implemented according to the techniques of the present invention, and that lens 100 depicted in FIG. 1A is merely exemplary.

For example, referring now to FIGS. 1B and 1C, there is shown an example of an implementation of the present invention in eyeglasses 110. Here, each lens 100 of eyeglasses contains the filter materials described herein, so as to filter and rebalance sodium light according to the techniques of the present invention. Again, the particular design of eyeglasses 110 is exemplary and is provided for illustrative purposes only. One skilled in the art will recognize that other designs, styles, and/or dimensions can be used without departing from the essential characteristics of the invention.

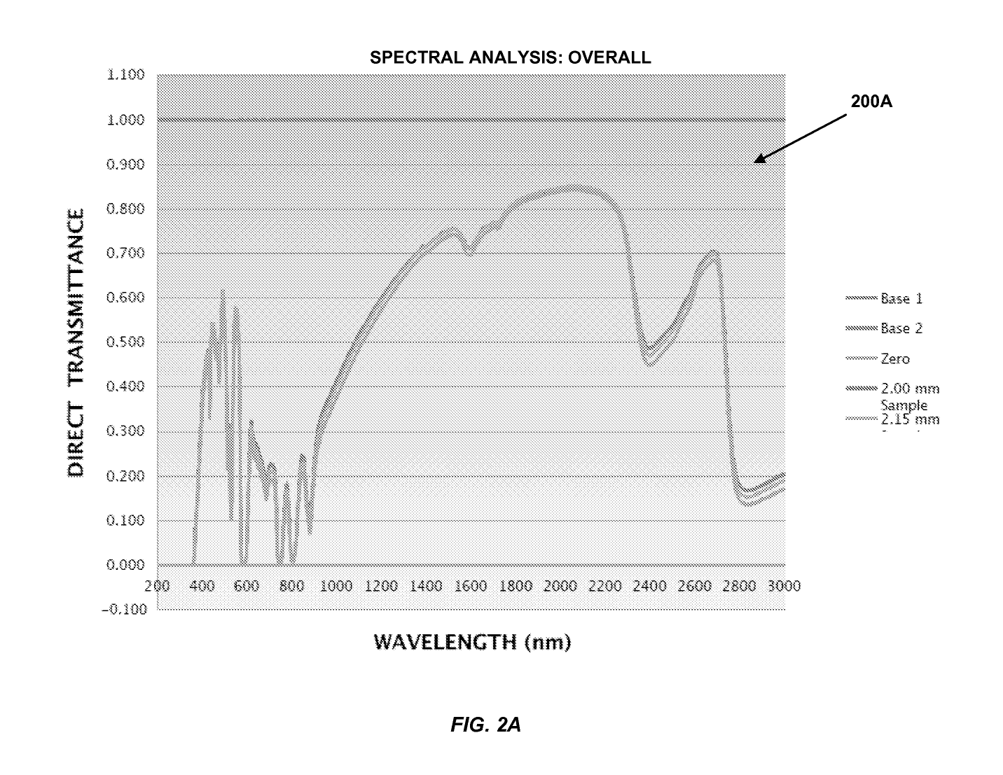

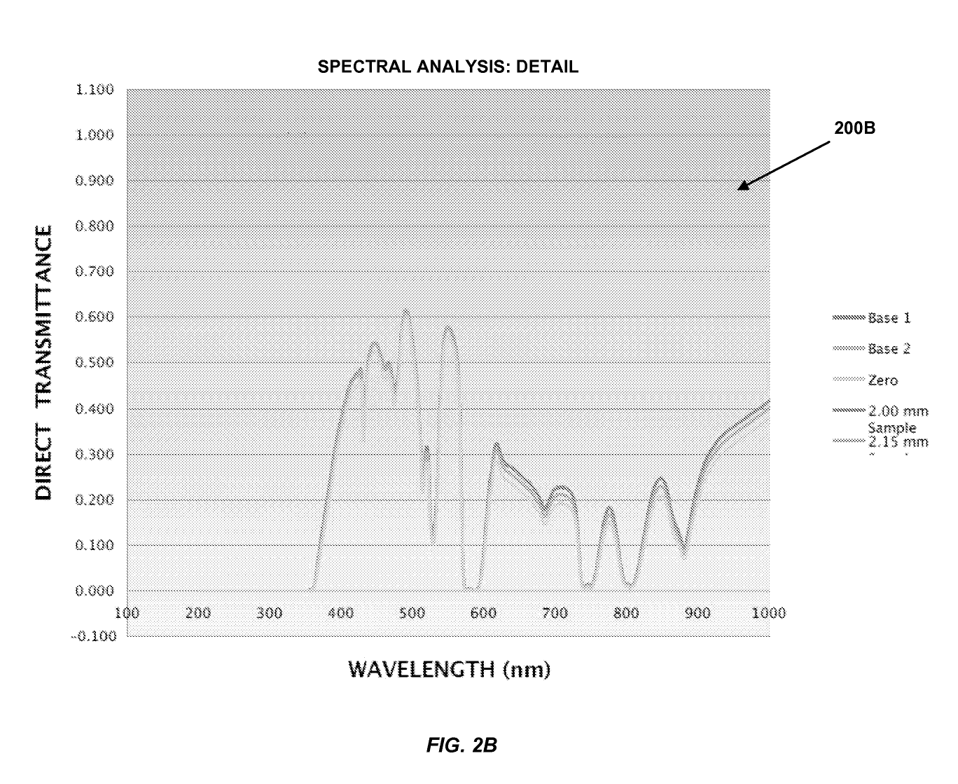

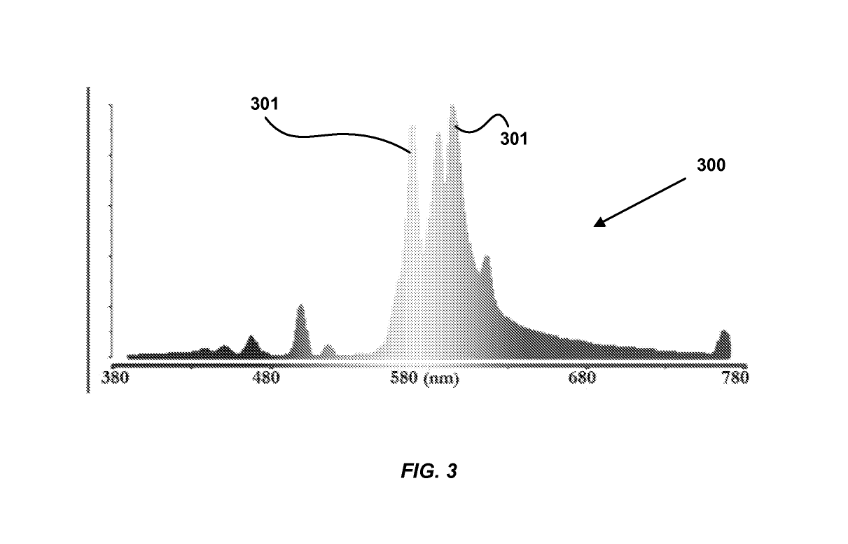

Referring now to FIGS. 2A and 2B, there are shown graphs 200A, 200B depicting results of a spectral analysis of a lens manufactured according to an embodiment of the present invention. Graphs 200A, 200B depict, for example, transmission of light through a lens 100 manufactured according to the techniques described herein. Each graph 200A, 200B depicts degrees of transmission of light at various frequencies, with 1.0 representing 100% transmission and 0.0 representing zero transmission. Graph 200A shows an overall spectrum, ranging from wavelengths of 200 to 3000 nm, while graph 200B shows a detail of the same spectrum, ranging from wavelengths of 100 to 1000 nm.

The visible spectrum, for humans, lies between approximately 300 and 900 nm. In at least one embodiment, the filter of the present invention operates, at least in part, in the area surrounding the 589 nm wavelength emitted by HPS lighting. As can be seen from graph 200B, the filter or lens of the present invention dramatically reduces transmission surrounding the 589 nm wavelength. In addition, in at least one embodiment, the filter or lens of the present invention selectively attenuates other wavelengths as well, so as to color-balance the overall spectrum of transmitted light and thereby approximate natural daylight. In at least one embodiment, this color-balancing is achieved by the addition of the specific metal oxides described above; in other embodiments, other compositions can be used to achieve the desired color balancing.

In at least one embodiment, color-balancing as performed by selectively attenuating blue and green light in the 470-500 nanometer wavelength and/or violet light in the 430-450 nanometer wavelength. As can be seen in graph 200B, other wavelengths of light can also be selectively attenuated, so as to provide further color-balancing. For example, magenta light at 750 nm is attenuated by CuO and Cr₂O₃. The attenuations at 800 nm and 890 nm fall outside the visual spectrum.

The techniques of the present invention thus provide lenses and/or filters that yield a color-balanced spectrum which improves over those generated by conventional filters using neodymium (Nd) and/or praseodymium (Pr), which have a tendency to generate an unbalanced, reddish hue.

Table 1 depicts an example of a chemical composition for producing a glass lens or filter according to one embodiment of the present invention. One skilled in the art will recognize that the depicted chemical composition is merely exemplary, and that many variations are possible.

TABLE 1

| Formula | Weight | Wt % | Mole % | Appen |
|---|---|---|---|---|
| SiO2 | 45.330586 | 60.580680 | 65.634808 | 25.84 |
| Nd2O3 | 6.785503 | 9.068279 | 1.754423 | 0.00 |
| AL2O3 | 0.016099 | 0.021515 | 0.013735 | 0.00 |
| | 52.13 | 69.67% | 67.40% | 25.83 |
| Na2O | 11.686714 | 15.618352 | 16.405404 | 64.80 |
| K2O | 0.000540 | 0.000722 | 0.000499 | 0.00 |
| | 11.69 | 15.62% | 16.41% | 64.80 |
| ZnO | 0.001809 | 0.002417 | 0.001934 | 0.00 |
| MgO | 2.138887 | 2.858450 | 4.617527 | 2.77 |
| CaO | 3.025129 | 4.042841 | 4.693385 | 6.10 |
| | 5.17 | 6.90% | 9.31% | 8.87 |
| Fe2O3 | 0.015677 | 0.020950 | 0.008541 | 0.01 |
| B2O3 | 4.821300 | 6.443280 | 6.024250 | −3.01 |
| As2O3 | 0.261136 | 0.348987 | 0.114838 | 0.00 |
| | 5.10 | 6.81% | 6.15% | −3.00 |
| TiO2 | 0.000765 | 0.001022 | 0.000833 | 0.00 |
| S | 0.000297 | 0.000397 | 0.000806 | 0.00 |
| P2O3 | 0.002000 | 0.002673 | 0.001583 | 0.00 |
| | 0.00 | 0.00% | 0.00% | 0.00 |
| Pr2O3 | 0.096346 | 0.128759 | 0.025414 | 0.00 |
| CuO | 0.639494 | 0.854633 | 0.699433 | 0.21 |
| Cr2O3 | 0.004522 | 0.006043 | 0.002588 | 0.00 |
| | 0.74 | 0.99% | 0.73% | .021 |
| <SO2> | 0.001089 | | | |
| <oxy> | −0.086645 | | | |
| <NO2> | 1.082000 | | | |
| <LOl> | 0.000270 | | | |
| <H2O> | 2.911100 | | | |
| <F> | 0.600000 | | | |
| <CO2> | 10.729086 | | | |
| <Cl> | 0.231549 | | | |
| | 15.47 | | | |

In this table, “Appen” refers to the coefficient of thermal expansion, taking into account both linear and volumetric thermal expansion.

Table 2 depicts an ingredient list for producing a glass lens or filter according to the chemical composition shown in Table 1. One skilled in the art will recognize that other materials can be used, and that materials can be used in other quantities and/or proportions than those listed.

TABLE 2

| Material | Quantity |
|---|---|
| s1-puresil: Quartz sand | 45.00 lbs. |
| Soda Lime | 14.50 lbs. |
| 5-bor: Boron | 9.90 lbs. |
| Dolomite | 9.90 lbs. |
| Neodymium oxide | 6.00 lbs. + |
| | 400.00 g |
| Arsenic | 123.00 g |
| Sulphur nitrate | 2.00 lbs. |
| Ssf | 1.00 lbs. |
| Black copper | 293.00 g |

Table 3 depicts a summary of the proportions of various materials in producing a glass lens or filter according to the chemical composition shown in Table 1.

TABLE 3

| Material Group | Total (%) |
|---|---|
| RO | 7.76 |
| RO₂ | 60.58 |
| R₂O | 15.62 |
| R₂O₃ | 16.04 |

In the above description, for purposes of explanation, numerous specific details are set forth in order to provide a thorough understanding of the invention. It will be apparent, however, to one skilled in the art that the invention can be practiced without these specific details.

For example, one skilled in the art will recognize that other formulations, compositions, materials, and arrangements can be used in constructing a lens and/or filter according to the techniques of the present invention, and that the invention can be used for purposes other than those described.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. An optically transmissive apparatus, comprising:
a substrate;
at least one material, added to the substrate, adapted to modify a light spectrum of incoming high-pressure sodium light so as to reduce sodium flare and further adapted to modify the light spectrum so as to provide the appearance of a natural daylight balanced light spectrum.

2. The apparatus of claim 1, wherein the at least one material comprises:
at least one first material adapted to modify the light spectrum of incoming high-pressure sodium light to reduce sodium flare; and
at least one second material adapted to modify the light spectrum of incoming high-pressure sodium light so as to provide the appearance of a natural daylight balanced light spectrum.

3. The apparatus of claim 1, wherein the at least one material comprises at least one selected from the group consisting of:
a first material, added to the substrate, adapted to attenuate red/yellow light;
a second material, added to the substrate, adapted to attenuate blue and green light; and
a third material, added to the substrate, adapted to attenuate violet light.

4. The apparatus of claim 1, wherein the at least one material comprises at least one selected from the group consisting of:
a first material, added to the substrate, adapted to attenuate light in a range of wavelengths substantially between 570 and 590 nanometers;
a second material, added to the substrate, adapted to attenuate light in a range of wavelengths substantially between 470 and 500 nanometers; and
a third material, added to the substrate, adapted to attenuate light in a range of wavelengths substantially between 430 and 450 nanometers.

5. The apparatus of claim 4, wherein the first material comprises at least one selected from the group consisting of:
neodymium; and
praseodymium.

6. The apparatus of claim 4, wherein the second material comprises at least one selected from the group consisting of:
cerium oxide; and
titanium oxide.

7. The apparatus of claim 4, wherein the second material comprises at least one selected from the group consisting of:
black copper oxide; and
chromium oxide.

8. The apparatus of claim 4, further comprising:
a fourth material, added to the substrate, adapted to attenuate light in a range of wavelengths approximating 750 nm.

9. The apparatus of claim 1, wherein the substrate comprises glass.

10. The apparatus of claim 1, wherein the apparatus comprises a filter.

11. The apparatus of claim 1, wherein the apparatus comprises a lens.

12. The apparatus of claim 1, wherein the apparatus comprises at least one selected from the group consisting of:
a window;
eyeglasses;
sunglasses;
a contact lens;
eyewear; and
a surface of a light bulb.

13. A method for constructing an optically transmissive apparatus, comprising:
constructing a substrate;
adding at least one material to the substrate, the at least one material being adapted to modify a light spectrum of incoming high-pressure sodium light so as to reduce sodium flare and further adapted to modify the light spectrum so as to provide the appearance of a natural daylight balanced light spectrum.

14. The method of claim 13, wherein adding the at least one material to the substrate comprises:
adding, to the substrate, at least one first material adapted to modify the light spectrum of incoming high-pressure sodium light to reduce sodium flare; and
adding, to the substrate, at least one second material adapted to modify the light spectrum of incoming high-pressure sodium light so as to provide the appearance of a natural daylight balanced light spectrum.

15. The method of claim 13, wherein adding the at least one material to the substrate comprises adding at least one selected from the group consisting of:
a first material, adapted to attenuate red/yellow light;
a second material, adapted to attenuate blue and green light; and
a third material, adapted to attenuate violet light.

16. The method of claim 13, wherein adding the at least one material to the substrate comprises adding at least one selected from the group consisting of:
a first material, adapted to attenuate light in a range of wavelengths substantially between 570 and 590 nanometers;
a second material, adapted to attenuate light in a range of wavelengths substantially between 470 and 500 nanometers; and
a third material, adapted to attenuate light in a range of wavelengths substantially between 430 and 450 nanometers.

17. The method of claim 16, wherein adding the first material comprises adding, to the substrate, at least one selected from the group consisting of:
neodymium; and
praseodymium.

18. The method of claim 16, wherein adding the second material comprises adding, to the substrate, at least one selected from the group consisting of:
cerium oxide; and
titanium oxide.

19. The method of claim 16, wherein adding the second material comprises adding, to the substrate, at least one selected from the group consisting of:
black copper oxide; and
chromium oxide.

20. The method of claim 16, further comprising:
adding, to the substrate, a fourth material adapted to attenuate light in a range of wavelengths approximating 750 nm.

21. The method of claim 13, wherein the substrate comprises glass.

22. The method of claim 13, wherein the apparatus comprises a filter.

23. The method of claim 13, wherein the apparatus comprises a lens.

24. The method of claim 13, wherein the apparatus comprises at least one selected from the group consisting of:
a window;
eyeglasses;
sunglasses;
a contact lens;
eyewear; and
a surface of a light bulb.
